(19) United States
(12) Patent Application Publication
(10) Pub. No.: US 2016/0163420 A1
(43) Pub. Date: Jun. 9, 2016

(54) Insulated Wire and Dynamo-Electric Machine Using the Same

(71) Applicant: HITACHI, LTD., Tokyo (JP)

(72) Inventors: Koutarou ARAYA, Tokyo (JP); Satoru AMOU, Tokyo (JP); Shintarou TAKEDA, Tokyo (JP); Toshiyuki KOBAYASHI, Tokyo (JP); Tadashi ARAI, Tokyo (JP)

(21) Appl. No.: 14/905,189

(22) PCT Filed: Jul. 22, 2013
(86) PCT No.: PCT/JP2013/069794

§ 371 Date: Jan. 14, 2016

(51) Int. Cl. H01B 7/29; H01B 3/30; H01B 7/02

(52) U.S. Cl. CPC H01B 7/292; H01B 7/0216; H01B 3/308

(57) ABSTRACT

An insulated wire producible at low cost and excellent in heat resistance and voltage resistance and a dynamo-electric machine using the insulated wire are provided. The insulated wire includes a conductor and a resin laminated body covering the conductor and formed by a plurality of resin layers being stacked, wherein the resin layer of an outermost layer in the resin laminated body is formed from a resin having maximum heat resistance among resins forming the plurality of resin layers.

### TECHNICAL FIELD

The present invention relates to an insulated wire and a dynamo-electric machine using the insulated wire.

### BACKGROUND ART

Currently, further downsizing and higher power output of dynamo-electric machines such as driving motors used for household electric appliances, industrial electric appliances, ships, railways, electric vehicles and the like are being promoted.

To achieve downsizing or higher power output of a dynamo-electric machine, high-densities of winding and improvements of the packing factor of the dynamo-electric machine are needed and it is necessary to prevent self-heating of winding and a dielectric breakdown caused by a close interwinding partial discharge to attain high-densities of winding.

Also in inverter control whose application to driving motors is being broadened, a surge voltage generated by switching could cause a dielectric breakdown like a partial discharge, posing a problem.

Thus, more superior heat resistance and voltage resistance (hereinafter, referred to as voltage resistance) are demanded from an insulating resin used for an insulated wire to be wound.

Thus, PTL 1 discloses, as a technology to provide an insulated wire having a high discharge generating voltage and excellent in insulation performance retaining property, an inverter surge resistant insulated wire including an enamel baking layer of at least one layer on an outer circumference of a conductor and an extruded coating resin layer of at least one layer on an outer side thereof and also including a bond layer between the enamel baking layer and the extruded coating resin layer to increase the adhesive strength of the enamel baking layer and the extruded coating resin layer with the bonding layer acting as a medium, wherein the total of thickness of the enamel baking layer, the extruded coating resin layer, and the bonding layer is 60 μm or more, the thickness of the enamel baking layer is 50 μm or less, the extruded coating resin layer contains a polyphenylene sulfide polymer whose melt viscosity at 300° C. is 100 Pa·s or more, thermoplastic elastomer (2 to 8% by weight), and an antioxidant, and the wire is made of a polyphenylene sulfide resin composition whose tensile modulus of elasticity at 25° C. is 2500 MPa or more and whose tensile modulus of elasticity at 250° C. is 10 MPa or more.

### CITATION LIST

### Patent Literature

PTL 1: JP 2010-055964 A

### SUMMARY OF INVENTION

### Technical Problem

The heat resistance of an insulated wire can be ensured by coating the outer circumference of a conductor with a resin material excellent in heat resistance.

However, the insulated wire is generally required to have, in addition to heat resistance, various characteristics such as voltage resistance, mechanical strength, chemical stability, and water resistance/moisture resistance. Particularly, a conductor needs to be coated with a certain thickness or more to ensure voltage resistance of winding.

Thus, when a winding excellent in heat resistance and having voltage resistance is produced, it becomes necessary to form a sufficient thickness using a heat resistant resin material with which the winding is coated, causing a problem of increased material costs.

For example, in the insulated wire disclosed by PTL 1, the enamel baking layer, the bonding layer, and the extruded coating resin layer formed on the outer circumference of a conductor are all made of engineering plastic (see line 22 on page 15 to line 2 on page 16, first to fifth embodiments) and the insulated wire is considered to use expensive materials. PTL 1 state that a conventional enamel layer can be used (see [0034] in lines 25 to 32 on page 8), but in such a case, whether heat resistance of an insulated wire can be ensured is not clear.

Further, as disclosed by PTL 1, it is necessary to repeat processes a large number of times to form a sufficiently thick film by the method of coating and baking, posing a problem of high manufacturing costs.

Therefore, a subject of the present invention is to provide an insulated wire producible at low cost and excellent in heat resistance and voltage resistance and a dynamo-electric machine using the insulated wire.

### Solution to Problem

To tackle the subject, an insulated wire according to the present invention includes a conductor and a resin laminated body formed by coating the conductor and stacking a plurality of resin layers, wherein the resin layer in an outermost layer of the resin laminated body is formed from a resin having highest heat resistance among resins forming the plurality of resin layers.

Also, a dynamo-electric machine according to the present invention includes the insulated wire.

### Advantageous Effects of Invention

According to the present invention, an insulated wire producible at low cost and excellent in heat resistance and voltage resistance and a dynamo-electric machine using the insulated wire can be provided.

### BRIEF DESCRIPTION OF DRAWINGS

FIG. 1 is a schematic sectional view of an insulated wire according to Example 1.

FIG. 2 is a schematic sectional view of an insulated wire according to Comparative Example 1.

FIG. 3 is a schematic sectional view of an insulated wire according to Example 2.

FIG. 4 is a schematic sectional view of an insulated wire according to Comparative Example 2.

FIG. 5 is a schematic sectional view of an insulated wire according to Example 3.

FIG. 6 is a schematic sectional view of an insulated wire according to Comparative Example 3.

### DESCRIPTION OF EMBODIMENT

Hereinafter, insulated wires according to an embodiment of the present invention and dynamo-electric machines using the insulated wires will be described in detail.

An insulated wire according to the present embodiment mainly includes a conductor and a resin laminated body.

The insulated wire is suitable for winding of a dynamo-electric machine and is an insulated wire that can be used in a high-density environment in which wires are in close contact with each other by being wound.

A conductor according to the present embodiment is a line conductor like a core wire of a common insulated wire and is formed from a copper wire, an aluminum wire, or an alloy of these wires.

As the copper wire, any one of touch pitch copper, oxygen free copper, and deoxidized copper may be used as a material thereof and an annealed copper wire or a hard-drawn copper wire may be used. The copper wire may also be a plated copper wire plated with tin, nickel, silver, aluminum on the surface thereof.

As the aluminum wire, a hard-drawn aluminum wire or a semihard-drawn aluminum wire may be used.

As the alloy wire, a copper-tin alloy, a copper-silver alloy, a copper-zinc alloy, a copper-chromium alloy, a copper-zirconium alloy, an aluminum-copper alloy, an aluminum-silver alloy, an aluminum-zinc alloy, an aluminum-iron alloy, and Aldrey Aluminium can be cited.

As the shape of a conductor according to the present embodiment, a round wire with a circular cross section or a flat wire with a rectangular cross section may be used. Also, a solid wire formed from one conductor or a stranded wire formed by stranding a plurality of conductors may be used.

A resin laminated body according to the present embodiment is formed by a plurality of resin layers formed from an insulating resin being stacked and forms an insulating film with which the entire outer circumference of the conductor is coated.

As the insulating resin forming each resin layer, any one of a crystalline thermoplastic resin, an amorphous thermoplastic resin, and a thermosetting resin may be used and as the thermoplastic resin, any one resin classified into general-purpose plastic, engineering plastic, and super-engineering plastic may be used.

In this specification, the engineering plastic means a plastic that has heat resistance allowing the plastic to be used for a long period in an environment of 100° C. or more, the tensile strength of 49 MPa or more, and the bending modulus of elasticity of 1.9 GPa or more and the super-engineering plastic means a plastic that, in addition, has heat resistance allowing the plastic to be used for a long period in an environment of 150° C. or more.

Examples of the general-purpose plastic include polyethylene, polyvinyl chloride, polystyrene, polypropylene, polymethyl methacrylate, polyvinyl alcohol, polybutyral, and polyethylene terephthalate.

Examples of the engineering plastic include polycarbonate, polyamide 6, polyamide 66, polyacetal, denatured polyphenylene ether, polybutylene terephthalate, glass-reinforced polyethylene terephthalate, and ultrahigh molecular weight polyethylene.

Examples of the super-engineering plastic include polysulfone, polyether sulfone, polyphenylene sulfide, polyallylate, polyamide-imide, polyether-imide, polyether ether ketone, liquid crystal polymer, polyimide, thermoplastic polyimide, polybenzimidazole, polymethylpentene, polycyclohexylene dimethylene terephthalate, polyamide 6T, polyamide 9T, polyamide 11, polyamide 12, syndiotactic polystyrene, and fluororesin (polytetrafluoroethylene, tetrafluoroethylene-perfluoroalkylvinylether copolymer, tetrafluoroethylene-ethylene copolymer, polyvinylidene difluoride and the like).

Examples of the thermosetting resin include phenol resin, melamine resin, urea resin, polyurethane, silicone resin, epoxy resin, unsaturated polyester and the like.

In a resin laminated body according to the present embodiment, the resin layer in the outermost layer is, among a plurality of resin layers constituting the resin laminated body, a resin layer formed from an insulating resin of the highest heat resistance. In other words, among the plurality of resin layers constituting the resin laminated body, inner layers positioned on the conductor side of the outermost layer are formed from any insulating resin having relatively low heat resistance.

As an insulating resin to form a resin layer to be the outermost layer, polytetrafluoroethylene, polyamide-imide, and polyimide excellent particularly in heat resistance are preferable. Therefore, an insulating resin whose heat resistance is lower than that of the above resins is used as an insulating resin to form inner layers positioned on the conductor side of the outermost layer

The inventors verified based on thermal analysis that heat resistance of an insulated wire mainly depends on the heat resistance of the outermost layer of a resin laminated body. Based on the above property, by forming the outermost layer of a resin laminated body from an insulating resin of the highest heat resistance to ensure heat resistance of the insulated wire, an insulated wire excellent in heat resistance can be obtained even if inner layers positioned on the conductor side of the outermost layer are formed from any insulating resin of relatively low heat resistance. Therefore, an insulated wire excellent in heat resistance can be obtained by, for example, forming the resin layer of the outermost layer from the super-engineering plastic and the inner layers positioned on the conductor side thereof from the engineering plastic or general-purpose plastic or forming the resin layer of the outermost layer from the engineering plastic and the inner layers positioned on the conductor side thereof from the general-purpose plastic.

The material cost of insulating resin tends to rise with increasing functionality of resin and this also applies to heat resistance. Therefore, the material costs can be cut without loss of heat resistance of an insulated wire by forming inner layers positioned on the conductor side of the outermost layer in a resin laminated body using a cheaper insulating resin.

When evaluating superiority in heat resistance of insulating resins, the classification of the general-purpose plastic, the engineering plastic, and the super-engineering plastic can serve as an indicator to a certain degree. However, the correct order of heat resistance of insulating resin types is not generally established. Thus, regarding insulating resins used to forma resin laminated body according to the present embodiment, more specifically, superiority of each insulating resin is compared by ranking the heat resistance thereof based on a heat resistance index to select the insulating resin type constituting each of the resin layer of the outermost layer and other resin layers of the inner layers.

In this specification, the heat resistance index is assumed to be an index calculated based on thermal analysis of resin according to a technique of kinetic analysis (see Takeo Ozawa, “Non-constant temperature kinetics (1) Case of single elementary process”, Thermal measurement, Japan Society of Calorimetry and Thermal Analysis, Jun. 30, 2004, Vol. 31, No. 3, pp. 125 to 132) of a decomposition reaction by the Ozawa method and to mean a holding temperature at which 20,000 hours are needed for a resin composition held at the constant temperature to decrease 5% by mass.

As a method of thermal analysis, a method (Friedman-Ozawa method) of measuring the temperature when the weight decreases 5% by mass by scanning at a plurality of rates of temperature rise is known.

In this method, activation energy of a decomposition reaction of an insulating resin involved in a decrease in weight can be derived by plotting the temperature when the measured weight decreases by a predetermined amount (for example, 5% by mass).

Also, a method (Ozawa-Flynn-Wall method) of measuring the time needed for the weight to decrease 5% by mass at two or more different holding temperatures is known. In this method, activation energy of a decomposition reaction of an insulating resin involved in a decrease in weight can be derived by plotting the time until the measured weight decreases (for example, 5% by mass).

The heat resistance index can be calculated from the value of activation energy derived by one of these methods.

As shown in the above publication, the calculated heat resistance index is a value under the assumption that the heat resistant life of a resin composition is determined by structural changes only and structural changes occur with one reaction. Therefore, even for insulating resins of the same type, if one of insulating resins contains an additive such as an antioxidant that lowers activation energy of a decomposition energy and the above plot has linearity, different heat resistance indexes are calculated for each and superiority in heat resistance could arise among insulating resins of the same type. In the present invention, a case in which a resin laminated body is formed according to superiority of heat resistance based on the heat resistance index even if insulating resins of the same type are laminated is included in the technical scope of the invention.

As the additive that lowers activation energy of a decomposition reaction, for example, a phenol antioxidant, a sulfur antioxidant, a phosphorus antioxidant, an amine antioxidant or the like can be used.

More specifically, examples of the phenol antioxidant include pentaerythritol tetrakis[3-(3,5-di-tert-butyl-4-hydroxyphenyl)propionate], 2,6-di-tert-butyl-4-methylphenol, 2,6-di-tert-butyl-4-methoxyphenol, 4,4′-butylidenebis(6-tert-butyl-3-methylphenol), 2,2′-methylenebis(6-tert-butyl-4-methylphenol), 4,4′-thiobis(6-tert-butyl-m-cresol), 1,3,5-trimethyl-2,4,6-tris(3,5-di-tert-butyl-4-hydroxybenzyl)benzene, 1,3,5-tris(3,5-di-tert-butyl-4-hydroxybenzyl)-1,3,5-triazine-2,4,6(1H,3H,5H)-trione, and 3,9-bis[2-[3-(3-tert-butyl-4-hydroxy-5-methylphenyl)propionyloxy]-1,1-dimethylethyl]-2,4,8,10-tetraoxaspiro[5.5]undecane, examples of the sulfur antioxidant include dilauryl-3,3′-thiodipropionate, dimyristyl-3,3′-thiodipropionate, distearyl-3,3′-thiodipropionate, and 2-mercaptobenzimidazole, examples of the phosphorus antioxidant include tridecyl phosphite, trilauryl phosphite, triphenyl phosphite, tris(nonyl phenyl)phosphite, tris(2,4-di-tert-butylphenyl)phosphite, diphenyl monodecyl phosphite, and 2,2-methylenebis(4,6-di-tert-butylphenyl)octyl phosphite, and examples of the amine antioxidant include 4,4′-diaminodiphenyl methane, N,N′-diphenyl-p-phenylenediamine, N-cyclohexyl-N′-phenyl-p-phenylenediamine, N-phenyl-2-naphthylamine, N,N′-dimethyl-2-naphthylamine, and N,N,N′,N′-tetramethyl-p-phenylenediamine.

The thickness of a resin laminated body according to the present embodiment is preferably set to 50 μm or more.

If the thickness of a resin laminated body is 50 μm or more, voltage resistance of insulated wires can be ensured in a highly dense state such that insulated wires are close to each other.

The thickness of the resin layer to be the outermost layer of a resin laminated body according to the present embodiment is preferably set to less than half the thickness of the whole resin laminated body. In other words, the total of thicknesses of inner layers positioned on the conductor side of the outermost layer is preferably set to half the thickness of the whole resin laminated body or more.

If the thickness of each resin layer in a resin laminated body is related as described above, most of the resin laminated body required to have predetermined thicknesses can be formed from any insulating resin and the material cost of the insulated wire can be cut while voltage resistance being ensured.

Inner layers positioned on the conductor side of the outermost layer in a resin laminated body according to the present embodiment are preferably formed from thermoplastic resins.

As described above, heat resistance of an insulated wire is ensured even if any insulating resin is used for inner layers positioned on the conductor side of the outermost layer in a resin laminated body according to the present embodiment. Thus, by selecting a thermoplastic resin that is melted by heating as the resin type for inner layers positioned on the conductor side of the outermost layer, the inner layers can be formed by extrusion molding. Then, according to extrusion molding, the thickness needed to ensure pressure resistance of an insulated wire can be formed by one process and thus, compared with a case in which the application of varnish and baking are repeated, the manufacturing cost can be cut.

When a resin layer on the outer layer side is formed in a resin laminated body, it is necessary for a resin layer on the inner layer side not to be fluidized by heating accompanying application/baking or extrusion molding.

Thus, if the resin layer on the inner layer side is a crystalline thermoplastic resin, the heating temperature for application/baking or extrusion molding is preferably lower than the melting point of the crystalline thermoplastic resin. If the resin layer on the inner layer side is an amorphous thermoplastic resin, the heating temperature for application/baking or extrusion molding is preferably lower than the glass transition temperature of the amorphous thermoplastic resin.

For the outermost layer, by contrast, any method of the application and baking or extrusion molding may be used in accordance with the thickness to be formed.

Inner layers on the conductor side of the outermost layer in a resin laminated body according to the present embodiment may be formed from a latent thermosetting resin and a cross-linking agent. Accordingly, while moldability by extrusion molding in a non-cross-linked state is ensured during extrusion molding of the relevant resin layer, the resin can be made non-fluidized by heating by cross-linking the resin during molding of other layers on the outer layer side.

As the latent thermosetting resin, a resin having a nucleophilic reaction group or an electron donating reaction group can be cited and examples thereof include a phenoxy resin obtained by polymerizing bisphenol such as bisphenol A, bisphenol F, bisphenol E, bisphenol S or the like and epihalohydrin and other epoxy resins classified into the novolac type obtained by epoxidizing novolac such as phenol novolac or cresol novolac, the cyclic aliphatic type such as 3,4-epoxycyclohexylmethyl-3,4-epoxycyclohexanecarboxylate and bis({3,4-epoxycyclohexyl}methyl)adipate, the naphthalene type such as 1,6-dihydroxynaphthalenediglycidyl ether, and the long-chain aliphatic type such as diglycidyl ester of a long-chain fatty acid dimer.

As the cross-linking agent, block isocyanate or a bismaleimide compound capable of exhibiting cross-linking reaction activity by further heating after extrusion molding, though inactive at the heating temperature for extrusion molding.

Block isocyanate may be a compound in which isocyanate having a reaction group capable of polymerizing a latent thermosetting resin or polyisocyanate having a plurality of isocyanate groups is protected with a block agent.

Examples of the former block isocyanate include methacrylic acid-2-(0-[1′-methylpropylideneamino]carboxyamino)ethyl “Karenz MOI-BM” (manufactured by Showa Denko K.K.), 2-[(3,5-dimethylpyrazolyl)carbonylamino]ethylmethacrylate “Karenz MOI-BP” (manufactured by Showa Denko K.K.) and examples of the latter block isocyanate include aromatic isocyanate such as 4,4′-diphenylmethane diisocyanate, 2,4-tolylene diisocyanate, and 2,6-tolylene diisocyanate, aliphatic isocyanate such as hexamethylene diisocyanate and tetramethylene diisocyanate, and alicyclic isocyanate such as isophorone diisocyanate and dicyclohexylmethane-4,4′-diisocyanate protected with a block agent.

As the bismaleimide compound, 4,4′-diphenylmethane bismaleimide “BMI-1000” (manufactured by Daiwakasei Industry Co., Ltd.), polyphenylmethane bismaleimide “BMI-2000” (manufactured by Daiwakasei Industry Co., Ltd.), m-phenylmethane bismaleimide “BMI-3000” (manufactured by Daiwakasei Industry Co., Ltd.), bisphenol A diphenyl ether bismaleimide “BMI-4000” (manufactured by Daiwakasei Industry Co., Ltd.), 3,3′-dimethyl-5,5′-diethyl-4,4′-diphenylmethane bismaleimide “BMI-5000”, “BMI-5100” (manufactured by Daiwakasei Industry Co., Ltd.), 4-methyl-1,3-phenylene bismaleimide “BMI-7000” (manufactured by Daiwakasei Industry Co., Ltd.) or the like can be used.

Next, the method of manufacturing an insulated wire according to the present embodiment will be described.

The method of manufacturing an insulated wire according to the present embodiment is in conformance with the method of manufacturing a common insulated wire. That is, each resin layer constituting a resin laminated body is formed by using a method of extrusion molding using a thermoplastic resin or a method of applying varnish of a thermosetting resin and baking.

For example, for extrusion molding using a thermoplastic resin, an extrusion molding machine of a cross head die having a base in accordance with a desired wire shape is used.

An insulating resin material to form a resin layer is input into a hopper of the extrusion molding machine and supplied to a cylinder to be melted by being heated up to a temperature equal to or higher than the glass transition temperature. Then, the heated and melted insulating resin material is supplied to a cross head while being kneaded by a screw included in the cylinder.

A line conductive core wire is passed through the cross head. The conductive core wire is obtained by wire drawing in which the wire diameter is gradually reduced by passing the wire through dice. A resin layer constituting a resin laminated body is formed by the outer circumference of the conductive core wire being coated with a molten insulating resin material when the cross head passes. Then, the conductive core wires passes through a sizer to adjust the wire diameter and is cooled if necessary before being coated with an outer resin layer.

In the method of varnish application and baking, varnish produced by dissolving a thermosetting resin and various additives in a solvent such as N-methyl-2-pyrrolidone, dimethylsulfoxide, N,N-dimethylformamide, N,N-dimethylacetamide or the like is applied to the conductive core wire.

Then, the conductive core wire to which the varnish is applied is baked by being passed through a heating furnace so that the solvent is volatilized and a resin layer constituting the resin laminated body is formed. Then, the conductive core wire is cooled if necessary before being coated with an outer resin layer.

In the formation of a resin laminated body, it is preferable to improve wettability of the resin layer on the inner layer side on which the resin layer to be formed is stacked by surface treatment to improve adhesion of interfaces of a plurality of resin layers. Surface treatment to improve wettability includes ultraviolet irradiation treatment and plasma treatment.

A dynamo-electric machine according to the present embodiment includes common motor elements such as a rotor, a stator, and an output axis and also includes an insulated wire according to the above embodiment.

The insulated wire is wound around a stator core held by the stator.

By including an insulated wire excellent in heat resistance and voltage resistance, a dynamo-electric machine according to the present embodiment is suitable, for example, for a mechanical power generator or an electric power generator in household electric appliances, industrial electric appliances, ships, railways, electric vehicles and the like and has properties that make a dielectric breakdown by heat, a partial discharge, a surge voltage or the like less likely to occur particularly also in a small or high-power dynamo-electric machine.

### EXAMPLES

Next, examples of the present invention will be described more concretely, but the technical scope of the present invention is not limited to such examples.

### Example 1

An insulated wire according to the example formed by stacking two resin layers on a conductor is produced.

A round wire made of copper of 1 mm in diameter is used as the conductor.

The inner layer in the resin laminated body is formed from polyphenylene sulfide “Tohpren T-1” (manufactured by Tohpren) and the outer layer is formed from thermosetting polyimide varnish “SUNEVER SE-150” (Nissan Chemical Industries, Limited).

First, a resin layer (inner layer) of polyphenylene sulfide is formed by extrusion molding on the outer circumference of the round wire of 1 mm in diameter. The thickness of the resin layer (inner layer) is set to 0.2 mm.

Subsequently, thermosetting polyimide is applied to the outer circumference of the resin layer (inner layer) and temporarily dried at room temperature.

Then, the resin layer (outer layer) of polyimide is formed by baking at 240° C. for two hours in a constant temperature oven to produce an insulated wire according to Example 1. The thickness of the formed resin layer (outer layer) is about 0.02 mm.

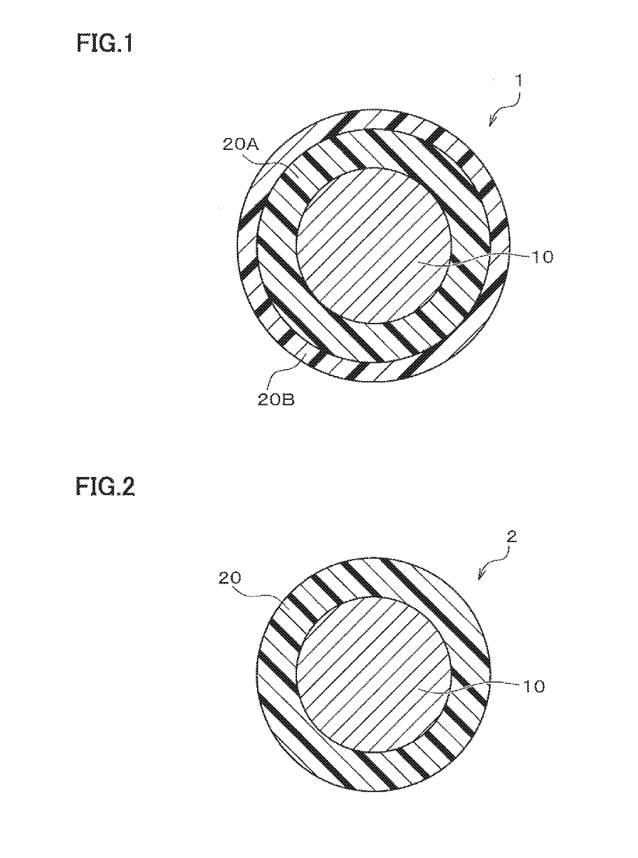

FIG. 1 is a schematic sectional view of an insulated wire according to Example 1.

In a produced insulated wire 1 according to Example 1, a conductor 10 is a core wire whose cross section is circular and the entire circumference of the conductor 10 is coated with a resin laminated body (20A, 20B) formed by two resin layers of a resin layer (inner layer) 20A of polyphenylene sulfide and a resin layer (outer layer) 20B of polyimide being stacked.

Next, heat resistance of the insulated wire according to Example 1 is checked.

The produced insulated wires are left at rest inside constant temperature ovens of 200° C., 220° C., and 240° C. to measure respective weight decrease times in which the weight decreases 5% by mass.

Activation energy of a thermal decomposition reaction is calculated by plotting the measured weight decrease time at each temperature to determine the temperature as the heat resistance index at which 20,000 hours are needed for the weight to decrease 5% by mass.

As a result, the heat resistance index of the insulated wire according to Example 1 is 220° C.

### Comparative Example 1

An insulated wire according to the comparative example formed by stacking one resin layer on a conductor is produced.

A round wire made of copper of 1 mm in diameter is used as the conductor.

The resin layer is formed from polyphenylene sulfide “Topren T-1” (manufactured by Topren).

A resin layer of polyphenylene sulfide is formed by extrusion molding on the outer circumference of a round wire of 1 mm in diameter to produce an insulated wire according to Comparative Example 1. The thickness of the resin layer is set to 0.2 mm.

FIG. 2 is a schematic sectional view of an insulated wire according to Comparative Example 1.

In a produced insulated wire 2 according to Comparative Example 1, the conductor 10 is a core wire whose cross section is circular and the entire circumference of the conductor 10 is coated with a resin layer 20 of polyphenylene sulfide.

Next, heat resistance of the insulated wire according to Comparative Example 1 is checked in the same manner as in Example 1.

As a result, the heat resistance index of the insulated wire according to Comparative Example 1 is 180° C.

Results of the heat resistance indexes of Example 1 and Comparative Example 1 described above confirm that heat resistance of an insulated wire depends on the heat resistance of the resin layer of the outermost layer of a resin laminated body.

The above results also indicate that the influence of thickness of the resin layer of the outermost layer is small for the development of heat resistance.

### Example 2

An insulated wire according to the example formed by stacking three resin layers on a conductor is produced.

A round wire made of copper of 1 mm in diameter is used as the conductor.

The inner layer in the resin laminated body is formed from thermosetting polyimide varnish “SUNEVER SE-150” (Nissan Chemical Industries, Limited), the middle layer is formed from polyphenylene sulfide “Tohpren T-1┘ (manufactured by Tohpren), and the outer layer is formed from thermosetting polyimide varnish “SUNEVER SE-150” (Nissan Chemical Industries, Limited).

First, thermosetting polyimide is applied to the outer circumference of a round wire of 1 mm in diameter and temporarily dried at room temperature.

Then, a resin layer (inner layer) of polyimide is formed by baking at 300° C. for one hour in a constant temperature oven. The thickness of the formed resin layer (inner layer) is about 0.01 mm.

Subsequently, a resin layer (middle layer) of polyphenylene sulfide is formed on the outer circumference of the resin layer (inner layer) by extrusion molding. The thickness of the resin layer (middle layer) is set to 0.2 mm.

Subsequently, thermosetting polyimide is applied to the outer circumference of the resin layer (middle layer) and temporarily dried at room temperature.

Then, the resin layer (outer layer) of polyimide is formed by baking at 240° C. for two hours in a constant temperature oven to produce an insulated wire according to Example 2. The thickness of the formed resin layer (outer layer) is about 0.02 mm.

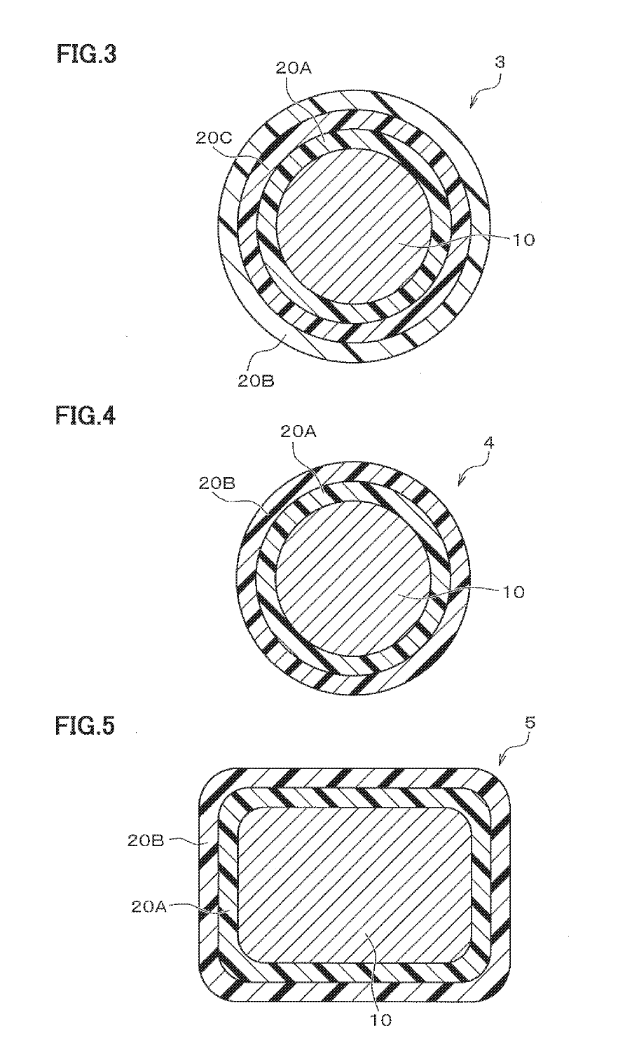

FIG. 3 is a schematic sectional view of an insulated wire according to Example 2.

In a produced insulated wire 3 according to Example 2, the conductor 10 is a core wire whose cross section is circular and the entire circumference of the conductor 10 is coated with a resin laminated body (20A, 20B, 20C) formed by three resin layers of the resin layer (inner layer) 20A of polyimide, the resin layer (middle layer) 20C of polyphenylene sulfide, and the resin layer (outer layer) 20B of polyimide being stacked.

Next, heat resistance of the insulated wire according to Example 2 is checked.

The produced resin laminated bodies are left at rest inside constant temperature ovens of 200° C., 220° C., and 240° C. to measure respective weight decrease times in which the weight decreases 5% by mass.

Activation energy of a thermal decomposition reaction is calculated by plotting the measured weight decrease time at each temperature to determine the temperature as the heat resistance index at which 20,000 hours are needed for the weight to decrease 5% by mass.

As a result, the heat resistance index of the insulated wire according to Example 2 is 220° C.

### Comparative Example 2

An insulated wire according to the comparative example formed by stacking two resin layers on a conductor is produced.

A round wire made of copper of 1 mm in diameter is used as the conductor.

The inner layer in the resin laminated body is formed from thermosetting polyimide varnish “SUNEVER SE-150” (Nissan Chemical Industries, Limited) and the outer layer is formed from polyphenylene sulfide “Tohpren T-1” (manufactured by Tohpren).

First, thermosetting polyimide is applied to the outer circumference of a round wire of 1 mm in diameter and temporarily dried at room temperature.

Then, a resin layer (inner layer) of polyimide is formed by baking at 300° C. for one hour in a constant temperature oven. The thickness of the formed resin layer (inner layer) is about 0.01 mm.

A resin layer (outer layer) of polyphenylene sulfide is formed by extrusion molding on the outer circumference of the resin layer (inner layer) to produce an insulated wire according to Comparative Example 2. The thickness of the resin layer (outer layer) is set to 0.2 mm.

FIG. 4 is a schematic sectional view of an insulated wire according to Comparative Example 2.

In a produced insulated wire 4 according to Comparative Example 2, the conductor 10 is a core wire whose cross section is circular and the entire circumference of the conductor 10 is coated with a resin laminated body (20A, 20B) formed by two resin layers of the resin layer (inner layer) 20A of polyimide and the resin layer (outer layer) 20B of polyphenylene sulfide being stacked.

Next, heat resistance of the insulated wire according to Comparative Example 2 is checked in the same manner as in Example 2.

As a result, the heat resistance index of the insulated wire according to Comparative Example 2 is 150° C.

Results of the heat resistance indexes of Example 1, Example 2, and Comparative Example 2 described above confirm that heat resistance of an insulated wire depends on the heat resistance of the resin layer of the outermost layer of a resin laminated body. The above results also indicate that the influence of resin layers on the conductor side of the outermost layer is small for the development of heat resistance.

### Example 3

An insulated wire according to the example formed by stacking two resin layers on a conductor is produced.

A flat wire made of copper of 1 mm×2 mm is used as the conductor.

The inner layer of the resin laminated body is formed using polyvinyl butyral varnish “S-LEC KS-10┘ (manufactured by Sekisui Chemical Co., Ltd.) and the outer layer is formed using polyvinyl butyral varnish in which pentaerythritoltetrakis[3-(3,5-di-tert-butyl-4-hydroxyphenyl)propionate] (#P0932: manufactured by Tokyo Chemical Industry Co., Ltd.) is dissolved as an antioxidant.

First, polyvinyl butyral is applied to the outer circumference of a flat wire of 1 mm×2 mm and temporarily dried at room temperature and then, a resin layer of polyvinyl butyral is formed by baking at 150° C. for two hours in a constant temperature oven.

Then, the operation of the application and baking is repeated to form a resin layer (inner layer) of about 0.2 mm in thickness.

Subsequently, polyvinyl butyral in which pentaerythritoltetrakis[3-(3,5-di-tert-butyl-4-hydroxyphenyl)propionate] (#P0932: manufactured by Tokyo Chemical Industry Co., Ltd.) is dissolved 2% by weight as an antioxidant is applied to the outer circumference of the resin layer (inner layer) and temporarily dried at room temperature and then, a resin layer (outer layer) of polyvinyl butyral is formed by baking at 150° C. for two hours in a constant temperature oven to produce an insulated wire according to Example 3. The thickness of the formed resin layer (outer layer) is about 0.02 mm.

FIG. 5 is a schematic sectional view of an insulated wire according to Example 3.

In a produced insulated wire 5 according to Example 3, the conductor 10 is a core wire whose cross section is rectangular and the entire circumference of the conductor 10 is coated with a resin laminated body (20A, 20B) formed by two resin layers of the resin layer 20A of polyvinyl butyral and the resin layer 20B of polyvinyl butyral containing an antioxidant being stacked.

Next, heat resistance of the insulated wire according to Example 3 is checked.

The produced resin laminated bodies are left at rest inside constant temperature ovens of 140° C., 160° C., and 180° C. to measure respective weight decrease times in which the weight decreases 5% by mass.

Activation energy of a thermal decomposition reaction is calculated by plotting the measured weight decrease time at each temperature to determine the temperature as the heat resistance index at which 20,000 hours are needed for the weight to decrease 5% by mass. As a result, the heat resistance index of the insulated wire according to Example 3 is 160° C.

### Comparative Example 3

An insulated wire according to the comparative example formed by stacking one resin layer on a conductor is produced.

A flat wire made of copper of 1 mm×2 mm is used as the conductor.

The resin layer is formed using polyvinyl butyral varnish “S-LEC KS-10” (Sekisui Chemical Co., Ltd.).

First, polyvinyl butyral is applied to the outer circumference of a flat wire of 1 mm×2 mm and temporarily dried at room temperature and then, a resin layer of polyvinyl butyral is formed by baking at 150° C. for two hours in a constant temperature oven.

Then, the operation of the application and baking is repeated to form a resin layer of about 0.2 mm in thickness, which is produced as an insulated wire in Comparative Example 3.

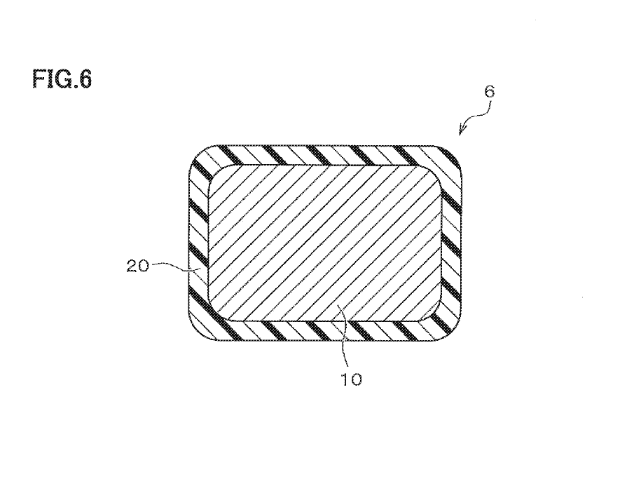

FIG. 6 is a schematic sectional view of an insulated wire according to Comparative Example 3.

In a produced insulated wire 6 according to Comparative Example 3, the conductor 10 is a core wire whose cross section is rectangular and the entire circumference of the conductor 10 is coated with the resin layer 20 of polyvinyl butyral.

Next, heat resistance of the insulated wire according to Comparative Example 3 is checked in the same manner as in Example 3.

As a result, the heat resistance index of the insulated wire according to Comparative Example 3 is 130° C.

Results of the heat resistance indexes of Example 3 and Comparative Example 3 confirm that heat resistance of an insulated wire is improved by addition of an antioxidant.

### Example 4

An insulated wire according to the example formed by stacking two resin layers on a conductor is produced.

A round wire made of copper of 1 mm in diameter is used as the conductor.

The inner layer in the resin laminated body is formed from a phenoxy resin “YP-55” (manufactured by Tohto Kasei Co., Ltd.) containing 3,3′-dimethyl-5,5′-diethyl-4,4′-diphenylmethane bismaleimide “BMI-5100” (Daiwakasei Industry Co., Ltd.), which is a bismaleimide compound, as a cross-linking agent and the outer layer is formed from thermosetting polyimide varnish “SUNEVER SE-150” (Nissan Chemical Industries, Limited).

First, a resin layer (inner layer) of phenoxy resin containing 3,3′-dimethyl-5,5′-diethyl-4,4′-diphenylmethane bismaleimide to be 20% by weight as a cross-linking agent is formed by extrusion molding on the outer circumference of a round wire of 1 mm in diameter. The thickness of the resin layer (inner layer) is set to 0.2 mm.

Then, thermosetting is caused by a cross-linking reaction through heating at 200° C. in a constant temperature oven.

Subsequently, thermosetting polyimide is applied to the outer circumference of the resin layer (inner layer) and temporarily dried at room temperature.

Then, a resin layer (outer layer) of polyimide is formed by baking at 200° C. for two hours in a constant temperature oven to produce an insulated wire according to Example 4. The thickness of the formed resin layer (outer layer) is about 0.02 mm.

Next, heat resistance of the insulated wire according to Example 4 is checked.

The produced resin laminated bodies are left at rest inside constant temperature ovens of 180° C., 200° C., and 220° C. to measure respective weight decrease times in which the weight decreases 5% by mass.

Activation energy of a thermal decomposition reaction is calculated by plotting the measured weight decrease time at each temperature to determine the temperature as the heat resistance index at which 20,000 hours are needed for the weight to decrease 5% by mass.

As a result, the heat resistance index of the insulated wire according to Example 4 is 190° C.

### Comparative Example 4

An insulated wire according to the comparative example formed by stacking one resin layer on a conductor is produced.

A round wire made of copper of 1 mm in diameter is used as the conductor.

The resin layer is formed from the phenoxy resin “YP-55” (manufactured by Tohto Kasei Co., Ltd.) containing 3,3′-dimethyl-5,5′-diethyl-4,4′-diphenylmethane bismaleimide “BMI-5100” (manufactured by Daiwakasei Industry Co., Ltd.), which is a bismaleimide compound, as a cross-linking agent.

First, a resin layer of phenoxy resin containing 3,3′-dimethyl-5,5′-diethyl-4,4′-diphenylmethane bismaleimide to be 20% by weight as a cross-linking agent is formed by extrusion molding on the outer circumference of a round wire of 1 mm in diameter. The thickness of the resin layer is set to 0.2 mm.

Then, thermosetting is caused by a cross-linking reaction through heating at 200° C. in a constant temperature oven to produce an insulated wire according to Comparative Example 4.

Next, heat resistance of the insulated wire according to Comparative Example 4 is checked in the same manner as in Example 4.

As a result, the heat resistance index of the insulated wire according to Comparative Example 4 is 150° C.

Results of the heat resistance indexes of Example 4 and Comparative Example 4 described above confirm that heat resistance of an insulated wire produced by extrusion molding also depends on the heat resistance of the resin layer of the outermost layer of a resin laminated body.

### Example 5

An insulated wire according to the example formed by stacking two resin layers on a conductor is produced.

A round wire made of copper of 1 mm in diameter is used as the conductor.

The inner layer in the resin laminated body is formed from the phenoxy resin “YP-55” (manufactured by Tohto Kasei Co., Ltd.) containing 2-[(3,5-dimethylpyrazolyl)carbonylamino]ethylmethacrylate “Karenz MOI-BP” (manufactured by Showa Denko K.K.), which is an isocyanate compound, as a cross-linking agent and the outer layer is formed from thermosetting polyimide varnish “SUNEVER SE-150” (Nissan Chemical Industries, Limited).

First, a resin layer (inner layer) of phenoxy resin containing 2-[(3,5-dimethylpyrazolyl)carbonylamino]ethylmethacrylate to be 20% by weight as a cross-linking agent is formed by extrusion molding on the outer circumference of a round wire of 1 mm in diameter. The thickness of the resin layer (inner layer) is set to 0.2 mm.

Then, thermosetting is caused by a cross-linking reaction through heating at 150° C. in a constant temperature oven.

Subsequently, thermosetting polyimide is applied to the outer circumference of the resin layer (inner layer) and temporarily dried at room temperature.

Then, a resin layer (outer layer) of polyimide is formed by baking at 220° C. for two hours in a constant temperature oven to produce an insulated wire according to Example 5. The thickness of the formed resin layer (outer layer) is about 0.02 mm.

Next, heat resistance of the insulated wire according to Example 5 is checked. The produced resin laminated bodies are left at rest inside constant temperature ovens of 180° C., 200° C., and 220° C. to measure respective weight decrease times in which the weight decreases 5% by mass.

Activation energy of a thermal decomposition reaction is calculated by plotting the measured weight decrease time at each temperature to determine the temperature as the heat resistance index at which 20,000 hours are needed for the weight to decrease 5% by mass.

As a result, the heat resistance index of the insulated wire according to Example 5 is 190° C.

### Comparative Example 5

An insulated wire according to the example formed by stacking one resin layer on a conductor is produced.

A round wire made of copper of 1 mm in diameter is used as the conductor.

The resin layer is formed from the phenoxy resin “YP-55” (manufactured by Tohto Kasei Co., Ltd.) containing 2-[(3,5-dimethylpyrazolyl)carbonylamino]ethylmethacrylate “Karenz MOI-BP” (manufactured by Showa Denko K.K.), which is an isocyanate compound, as a cross-linking agent.

First, a resin layer of phenoxy resin containing 2-[(3,5-dimethylpyrazolyl)carbonylamino]ethylmethacrylate to be 20% by weight as a cross-linking agent is formed by extrusion molding on the outer circumference of a round wire of 1 mm in diameter. The thickness of the resin layer is set to 0.2 mm.

Then, thermosetting is caused by a cross-linking reaction through heating at 150° C. in a constant temperature oven to produce an insulated wire according to Comparative Example 5.

Next, heat resistance of the insulated wire according to Comparative Example 5 is checked in the same manner as in Example 5.

As a result, the heat resistance index of the insulated wire according to Comparative Example 5 is 150° C.

Results of the heat resistance indexes of Example 5 and Comparative Example 5 described above confirm that heat resistance of another insulated wire produced by extrusion molding also depends on the heat resistance of the resin layer of the outermost layer of a resin laminated body.

### Example 6

An insulated wire according to the example formed by stacking two resin layers on a conductor is produced.

A round wire made of copper of 1 mm in diameter is used as the conductor. The inner layer in the resin laminated body is formed from the phenoxy resin “YP-55” (manufactured by Tohto Kasei Co., Ltd.) containing 2-[(3,5-dimethylpyrazolyl)carbonylamino]ethylmethacrylate “Karenz MOI-BP” (manufactured by Showa Denko K.K.), which is an isocyanate compound, as a cross-linking agent and the outer layer is formed from thermosetting polyimide varnish “SUNEVER SE-150” (Nissan Chemical Industries, Limited) in which the phenoxy resin is dissolved.

First, a resin layer (inner layer) of phenoxy resin containing 2-[(3,5-dimethylpyrazolyl)carbonylamino]ethylmethacrylate to be 20% by weight as a cross-linking agent is formed by extrusion molding on the outer circumference of a round wire of 1 mm in diameter. The thickness of the resin layer (inner layer) is set to 0.2 mm.

Then, thermosetting is caused by a cross-linking reaction through heating at 150° C. in a constant temperature oven.

Subsequently, thermosetting polyimide in which the phenoxy resin is dissolved to be 20% by weight is applied to the outer circumference of the resin layer (inner layer) and temporarily dried at room temperature.

Then, a resin layer (outer layer) of polyimide is formed by baking at 220° C. for two hours in a constant temperature oven to produce an insulated wire according to Example 6. The thickness of the formed resin layer (outer layer) is about 0.03 mm.

Next, heat resistance of the insulated wire according to Example 6 is checked.

The produced resin laminated bodies are left at rest inside constant temperature ovens of 180° C., 200° C., and 220° C. to measure respective weight decrease times in which the weight decreases 5% by mass.

Activation energy of a thermal decomposition reaction is calculated by plotting the measured weight decrease time at each temperature to determine the temperature as the heat resistance index at which 20,000 hours are needed for the weight to decrease 5% by mass.

As a result, the heat resistance index of the insulated wire according to Comparative Example 6 is 180° C.

Results of the heat resistance indexes of Comparative Example 5 and Example 6 described above confirm that heat resistance of an insulated wire produced by extrusion molding also depends on the heat resistance of the resin layer of the outermost layer of a resin laminated body.

### REFERENCE SIGNS LIST

1, 2, 3, 4 Round wire (Insulated wire)
5, 6 Flat wire (Insulated wire)
10 Conductor
20, 20A, 20B, 20C Resin layer

1.-8. (canceled)

9. An insulated wire comprising:
a conductor; and
a resin laminated body covering the conductor and formed by a plurality of resin layers being stacked,
wherein the resin layer of an outermost layer in the resin laminated body is formed from a resin having maximum heat resistance among resins forming the plurality of resin layers, and
at least one layer of the plurality of resin layers is formed from a phenoxy resin which is a thermoplastic resin.

10. The insulated wire according to claim 9, wherein a thickness of the resin layer of the outermost layer is equal to or less than half a thickness of the resin laminated body.

11. The insulated wire according to claim 9, wherein the resin layer formed from a phenoxy resin contains a cross-linking agent.

12. The insulated wire according to claim 11, wherein the cross-linking agent is a bismaleimide compound.

13. The insulated wire according to claim 9, wherein the resin layer formed from a phenoxy resin is cross-linked by a bismaleimide compound.

14. The insulated wire according to claim 9, wherein the resin having maximum heat resistance is polyimide.

15. The insulated wire according to claim 9, wherein the plurality of resin layers are constituted by two layers of an outermost layer formed from polyimide and an inner layer formed from a phenoxy resin.

16. A dynamo-electric machine comprising an insulated wire including:
a conductor, and
a resin laminated body covering the conductor and formed by a plurality of resin layers being stacked,
wherein the resin layer of an outermost layer in the resin laminated body is formed from a resin having maximum heat resistance among resins forming the plurality of resin layers, and
at least one layer of the plurality of resin layers is formed from a phenoxy resin which is a thermoplastic resin.
